(19) United States
(12) Patent Application Publication
(10) Pub. No.: US 2014/0331244 A1
(43) Pub. Date: Nov. 6, 2014

(54) Object Model For Delivering Live Tv Programming Streams To Client Device

(71) Applicant: Motorola Mobility LLC, LIBERTYVILLE, IL (US)

(72) Inventor: Kuang M. Chen, San Diego, CA (US)

(21) Appl. No.: 14/331,743

(22) Filed: Jul. 15, 2014

Related U.S. Application Data
(63) Continuation of application No. 13/517,594, filed on Jun. 13, 2012.
(60) Provisional application No. 61/496,537, filed on Jun. 13, 2011.

(51) Int. Cl. H04N 21/266; H04N 21/442; H04N 21/482; H04N 21/24

(52) U.S. Cl. CPC H04N 21/266; H04N 21/24; H04N 21/442; H04N 21/482
USPC 725/14

(57) ABSTRACT

In embodiments of an object model for domain-based content mobility, a client object model architecture (146) is configured for scalable and adaptive implementation to interface a mobile client device (128) with a media server (126) for wireless, secure download of media content (136) to the mobile client device. The client object model architecture can be implemented for domain-based control of a software application that invokes a media player (142) on the mobile client device, and interfaces with the media server that communicates the media content to the mobile client device. The client object model architecture also controls domain discovery of the media server, domain-based registration of the mobile client device with the media server, channel change requests, and solicited and unsolicited channel changes.

### RELATED APPLICATIONS

This application is a continuation of U.S. application Ser. No. 13/517,594 filed Jun. 13, 2012, entitled “An Object Model for Delivering Live TV Programming Streams to Client Device,” which claims priority to U.S. Provisional Application Ser. No. 61/496,537 filed Jun. 13, 2011, entitled “An Object Model for Delivering Live TV Programming Streams to Client Device,” the disclosure of which are incorporated by reference herein in their entirety.

### BACKGROUND

The traditional notion of watching television at home has evolved into many different forms of viewing television content, on many different devices. For example, users can watch television content, such as live television, recorded television, and time-shifted programs and movies, on various devices, such as televisions, display devices, entertainment devices, computers, and even mobile devices, such as tablets and mobile phones. Media content that is streamed or otherwise communicated to a client device, such as media content wirelessly communicated to a mobile phone, needs to be maintained as secure and encrypted. However, current mobile phones are not typically implemented to decrypt the media content that is encrypted by some security systems for playback as a progressive download or streaming, and further, current mobile phones are not able to render high-definition media content.

The digital media content can be transcoded and then streamed or otherwise communicated to a client device for audio/video playback of the media content on the client device. For example, media content, such as streaming live television or recorded media content, can be communicated to a mobile phone for playback and display on the mobile phone. However, there are many inoperability issues pertaining to streaming digital media content to a mobile client device, such as content listing, accessing content metadata, copyrights verification, content protection, media streaming and download, content storage and management, device authentication, media content playback, and channel changing among more than one user.

Some conventional technologies that attempt to address these inoperability issues either do not specifically resolve the multiple user channel control problems, or address them in such a way as to limit the choice of solutions. For example, one such solution is DLNA (Digital Living Network Alliance), which attempts to address media content sharing in a home environment, but has a goal to achieve content inter-operability by a user having to select a set of protocol suites.

### BRIEF DESCRIPTION OF THE DRAWINGS

Embodiments of an object model for delivering live TV programming streams to client device are described with reference to the following Figures. The same numbers may be used throughout to reference like features and components that are shown in the Figures:

FIGS. 1A, 1B, and 1C illustrate example system embodiments in which embodiments of an object model for domain-based content mobility can be implemented.

FIG. 2 illustrates an example software stack for a client device in which embodiments of an object model for domain-based content mobility can be implemented.

FIG. 3 illustrates an example client object model architecture in accordance with one or more embodiments.

FIG. 4 illustrates an example of client device registration state transitions in accordance with one or more embodiments of an object model for domain-based content mobility.

FIG. 5 illustrates example method(s) of an object model for domain-based content mobility in accordance with one or more embodiments.

FIGS. 6-8 illustrate API object model communication sequence diagrams between the components, devices, and entities in a domain system in accordance with one or more embodiments.

FIG. 9 illustrates various components of an example electronic device that can implement embodiments of an object model for domain-based content mobility.

### DETAILED DESCRIPTION

In embodiments, an object model for domain-based content mobility can be implemented as a client object model architecture, such as a software development kit (SDK) that is scalable and adaptive to interface a mobile client device configured for wireless communication with a media server. For example, a client device, such as a mobile phone, an iPad®, Xoom®, or other tablet device, or computer can implement the client object model architecture for domain-based control of an application that invokes a media player on the client device, and interfaces with the media server that communicates media content to the client device. The client object model architecture also controls domain discovery of the media server, domain-based registration of the client device with the media server, command channel change, and unsolicited channel change with mDNS notifications.

In embodiments, the object model for domain-based content mobility is an abstraction of a set of objects that enable developers to write domain-based content mobility applications, such as for mobile client devices. The client object model architecture includes a set of classes, the associated methods, and the relationships between the classes. The object model provides an interface to address the inoperability issues described above, and allows different technology solutions to be implemented with the object model. Accordingly, the client object model architecture is flexible (not limited to a certain set of technologies) and extensible (as the object model itself can be expanded).

The client object model architecture provides for the design of a client device SDK interface layer, through which functionality can be implemented to include any one or combination of domain discovery, device registration and control, digital rights management (DRM), content streaming, channel change, secure content playback.

While features and concepts of an object model for domain-based content mobility can be implemented in any number of different devices, systems, networks, and/or configurations, embodiments of an object model for domain-based content mobility are described in the context of the following example devices, systems, and methods.

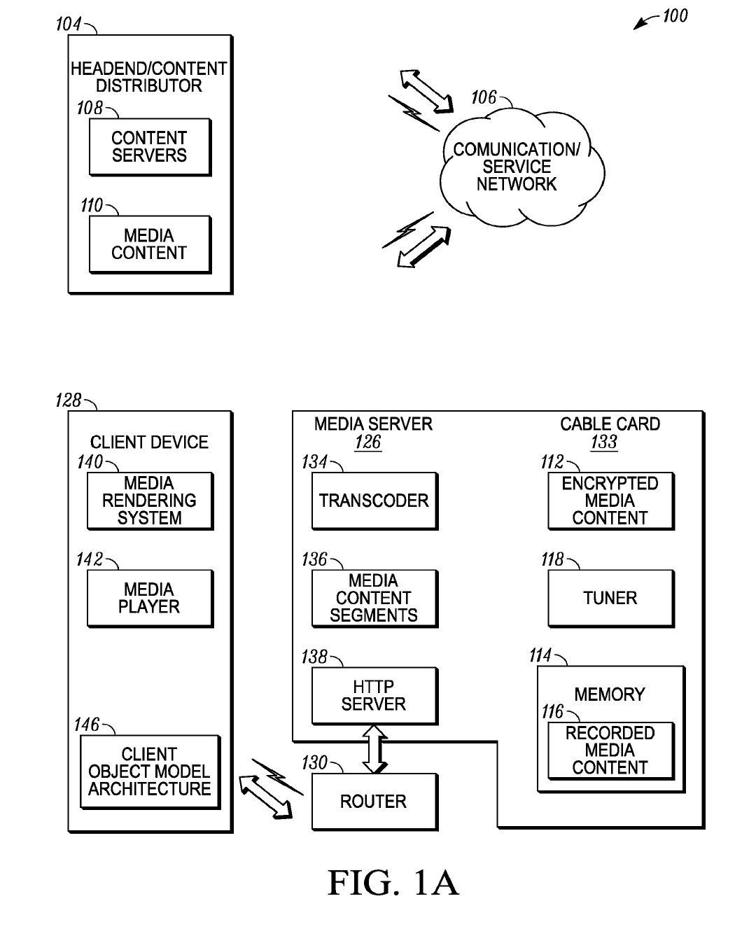

FIGS. 1A and 1B illustrate an example system 100 in which embodiments of an object model for domain-based content mobility can be implemented. The example system 100 illustrates one example of a streamer runtime environment. The system 100 includes a cable headend 104, which receives content via a service network 106. The system 100 also includes a media server 126, such as a Streamer, which receives media content from the headend 104 and delivers the content to a client device over a router 130 and home WIFI system 105. In one embodiment, the client device can include an iPad® or Motorola Xoom® or Motorola Xyboard,® or any other tablet, PC, or MAC computing workstation that is capable to receive media content from a media server 126. For example, a content distributor or head end 104 and/or other media content sources deliver media content and data to a media server (e.g. Motorola's Mover®, Streamer® or Televation® products) 126, via a communication service network 106, and ultimately to any number of various devices 128 via a WM® network 105 and router 130.

The content distributor or head end 104, includes content servers 108 to distribute media content 110 to the media server. The media server 126 receives the media content from the content distributor, which can include any type of audio, video, and/or image data in the form of television programming, movies, on-demand video, interactive games, advertisements, and the like. The media content can be encrypted.

Any of the services, devices, and servers can communicate via the communication network 106, which can be implemented to include a wired and/or a wireless network. The communication network can also be implemented using any type of network topology and/or communication protocol, and can be represented or otherwise implemented as a combination of two or more networks, to include IP-based networks and/or the Internet. The communication network may also include mobile operator networks that are managed by a mobile network operator and/or other network operators, such as a communication service provider, cell-phone provider, and/or Internet service provider.

The example system 100 also includes a media server 126 that is implemented to communicate media content to a client device 128 via a router 130 implemented for wired and/or wireless communication. The media server 126 may also be referred to herein as the Streamer or media streamer or media server. The media server 126 receives the media content from the head end 104 via a service network 106. The received media can be encrypted when it reaches the media server via cable. The media server 126 can decrypt the encrypted media content via the cable card 133, and then transcode the decrypted media content.

The media server 126 includes a transcoder 134 to format the media content for distribution to the client device 128 as media content segments 136 over an HTTP server 138 via the router 130. For example, the media server formats high-definition media content received from the head end, such as MP4 media content, to VGA formatted media content, or to an MP2 format. The media server 126, via the transcoder, can be implemented to then encrypt the formatted media content with an encryption key for communication to the client device via the router 130, so that the media content remains secure when communicated over WiFi™ or Ethernet to the client device.

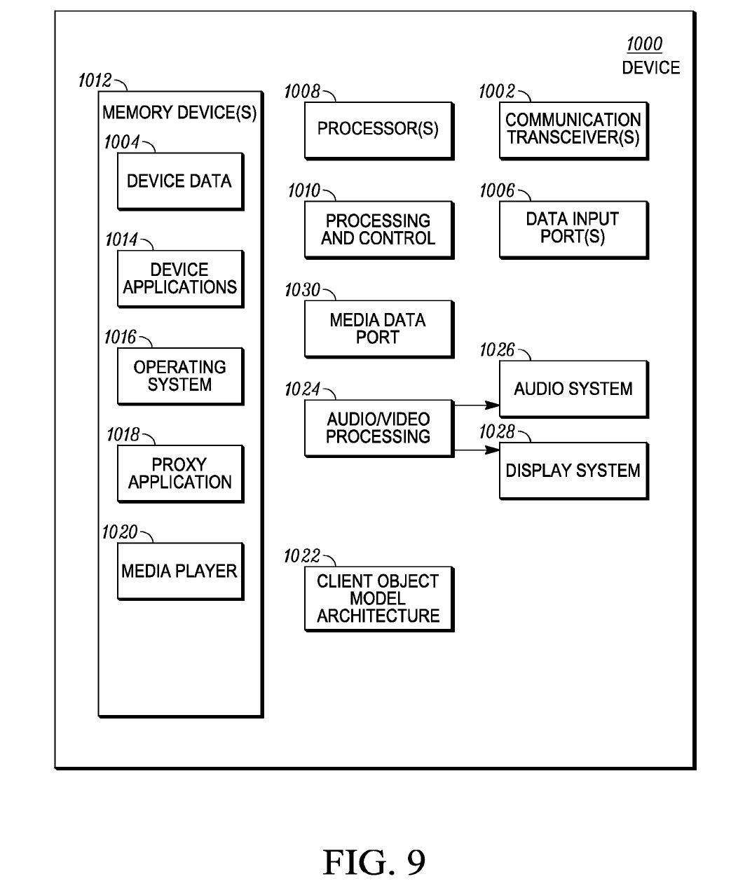

The media server 126 can be implemented with various components, such as a processor and memory devices, as well as with any combination of differing components as further described with reference to the example electronic device shown in FIG. 9. For example, the media server 126 can include memory that is implemented to buffer the media content segments 136 that are transcoded and maintained for delivery to the client device 128. Alternatively, the media server 126 may be implemented as a network-based media server (e.g., in the cloud) to decrypt the encrypted media content, transcode the decrypted media content, and re-encrypt the formatted media content for distribution to the client device as encrypted, formatted media content.

The client device 128 may be implemented as any one or combination of a communication, computer, media playback, gaming, entertainment, and/or electronic device, such as a mobile phone or tablet device that can be configured as a television client device to receive and playback media content. The client device can be implemented with various components, such as processor and memory devices, as well as with any combination of differing components as further described with reference to the example electronic device shown in FIG. 9. For example, the client device includes a media rendering system 140 to playback media content for viewing on an integrated display device. The client device can also include various client applications, such as a media player 142 that is implemented to manage the media content playback.

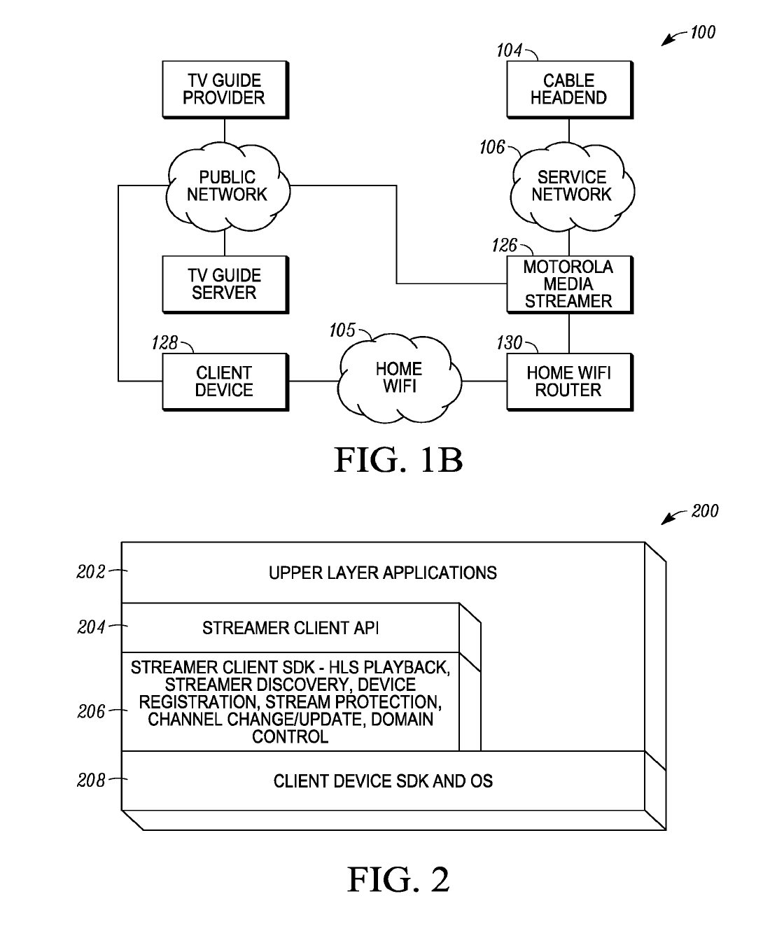

The client device also implements a client object model architecture 146 to implement the various embodiments of an object model for domain-based content mobility described herein. The client object model architecture can be implemented as part of a software stack on the client device, such as the software stack further described with reference to FIG. 2. The client object model architecture 146 enables the client device to list and describe media server content; support progressive download of the media content; protect the media content transport and storage; enforce digital rights management (DRM) rules; support content playback with the media player; enforce domain control; control and manage channel changes; determine the media player status; and/or personalize and register user devices. Additionally, the client device can be authenticated via certificates, implement domain control (e.g., the number of devices allowed to register in the domain is enforced), implement domain registration, domain de-registration, and/or domain re-registration.

In embodiments, functionality of the client device 128 with the client object model architecture 146 includes implementation of the client model architecture that invokes the media player 142 on the client device; domain discovery of the media server 126; domain-based registration of the client device with the media server; authentication of the client device to the media server; domain control for secure streaming of media content from the media server to the client device; digital rights management (DRM) of the secure streaming of the media content to the client device; acquisition of a media content list and metadata that corresponds to the media content; transcoding the media content for streaming to the client device; content streaming of the media content to the client device; download queue management of the media content that is queued for streaming to the client device; tune to current channel; channel playback; solicited channel change; unsolicited channel change; and get streamer (media server) status.

The discovery of a remote content source (e.g., the media server 126 or a network-based content source) is controlled by the domain registration and failure to register the client device 128 will result in failure to discover the remote content source. Further, media content consumption will not be allowed if registration fails. The client device 128 can discover a server name of the media server 126 that can be used to resolve an IP address for the media server. The media server supports Multicast DNS (mDNS) for the name discovery and IP address resolution mechanism. The mDNS protocol allows the client device to discover the media server by obtaining its fully-qualified name and IP address. The client device can first multicast a query looking for the media server and then the media server's mDNS server responds by providing the fully qualified name (FQN) and IP address. The client device can then build its name resolution table and, when the media server FQN is used in an HTTP URI, the message will be sent to the media server correctly.

FIG. 2 illustrates an example software stack 200 implemented in the client device 128 as described with reference to FIG. 1. In this example, the software stack includes upper layer applications 202 of the client device, a client device API set 204, a client device SDK 206 (software development kit), and an operating system SDK 208, such as ANDROID or iOS for Apple operating systems. In embodiments, the client device SDK 206 is an implementation of the client object model architecture 146 on the client device 128 for object model domain-based content mobility.

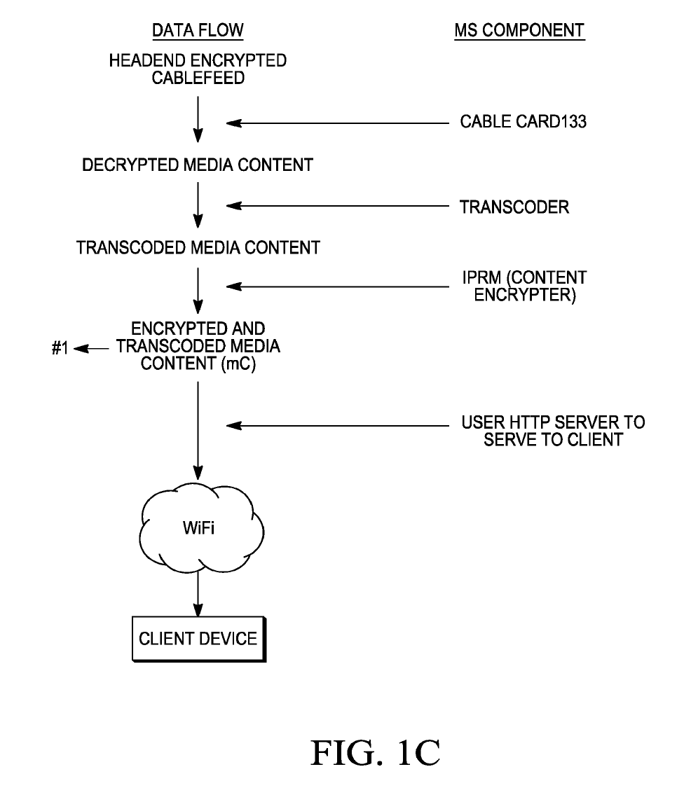

FIG. 3 illustrates an example client object model architecture 300 (e.g., a client device API object model), such as the client object model architecture 146 that is implemented on the client device 128 described with reference to FIG. 1. The client object model architecture 300 includes a set of classes, the associated methods, and the relationships between the classes, as configured by the client device SDK 206 described with reference to FIG. 2. A domain controller can be instantiated from the domain class 302 for overall control of the object model and to control the domain discovery of the media server 126, the domain-based registration of the client device with the media server, and the authentication of the client device to the media server so that the client device is trusted to receive encrypted (if enabled), formatted media content from the media server.

In addition to the domain class 302, the object model 300 includes a stream source class 306; a current channel class 308; and a channel player class 310 (e.g., such as to instantiate the media player 142 in the client device 128).

The stream source class 306 is the software component responsible for interacting with the media server 126. It supports the functions to get the channel list, to query the status of the media server and to change channels. The stream source class also provides methods to retrieve remote media content, such as remote media content that can be streamed to the client device. Remote media content usage control can be enforced by the IPRM system according to its copyrights. A remote content list includes the state of all the different remote media content and is sorted by the content state. An update to the remote content list is notified via a multicast domain name service (mDNS) message, and can provide attributes of the media content, such as the ID, descriptions, parental control information, playback duration, ratings, the content file URL(s), the icon URL(s), protection type, series name, and the episode name. The metadata that corresponds to the media content can also be stored persistently on the client device.

The media player agent class 310 represents the media player 142 that is instantiated by client software and includes functionality to control play of streaming media content on the client device. The stream source class 306 interacts with mDNS to perform functions (ie) channel changes). It invokes StreamSource class 306 and the Change Channel method of class 308 and class 310 to actually render the content. The current channel class 308 represents the new channel that has been tuned into. Its role is to help the media play component to play the new content at the client device. The media player agent class 310 interfaces with the media player 142 and invokes the media player 142 to play the media content.

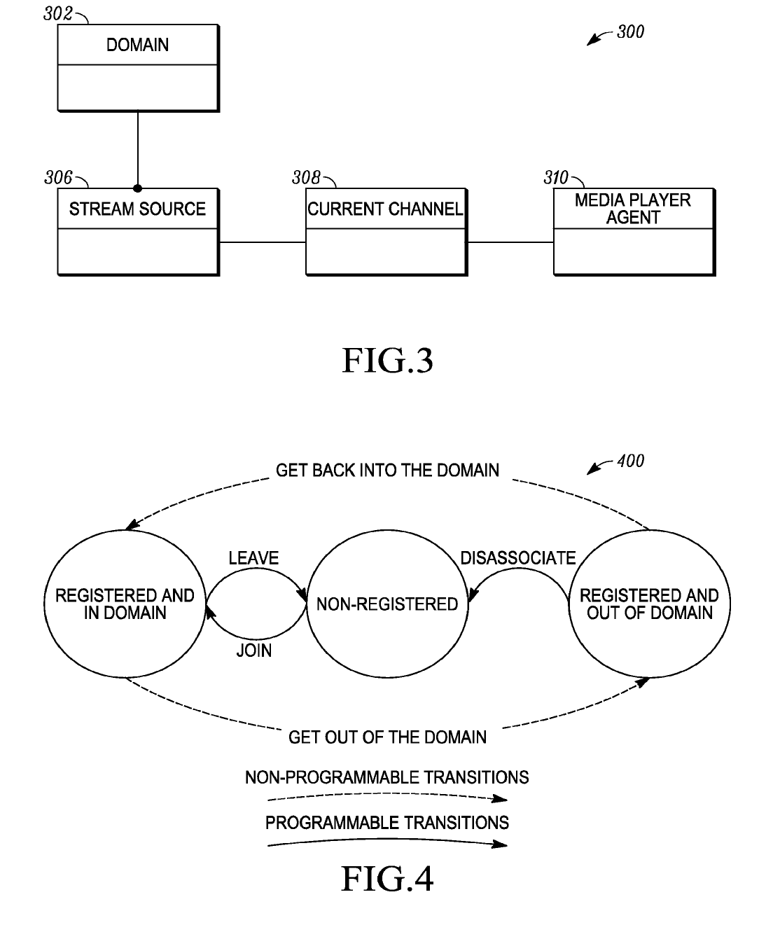

FIG. 4 illustrates an example state diagram 400 of client device registration state transitions, and registration to the domain object. As described above, client device registration is controlled by a domain controller that is instantiated from the domain class 302 of the client object model architecture. The example state diagram 400 includes a ‘registered and in domain’ state that indicates the client device is registered to the domain; a ‘non-registered’ state that indicates the client device is not registered to the domain; and a ‘registered and out of domain’ state that indicates the client device is registered in the domain, but is out of communication range. For example, the client device may be out of range to communicate in the domain via router 130 of the system described with reference to FIG. 1. The example state diagram 400 also illustrates programmable transitions to leave, join, and disassociate, as well as non-programmable transitions to get back into the domain, or get out of the domain.

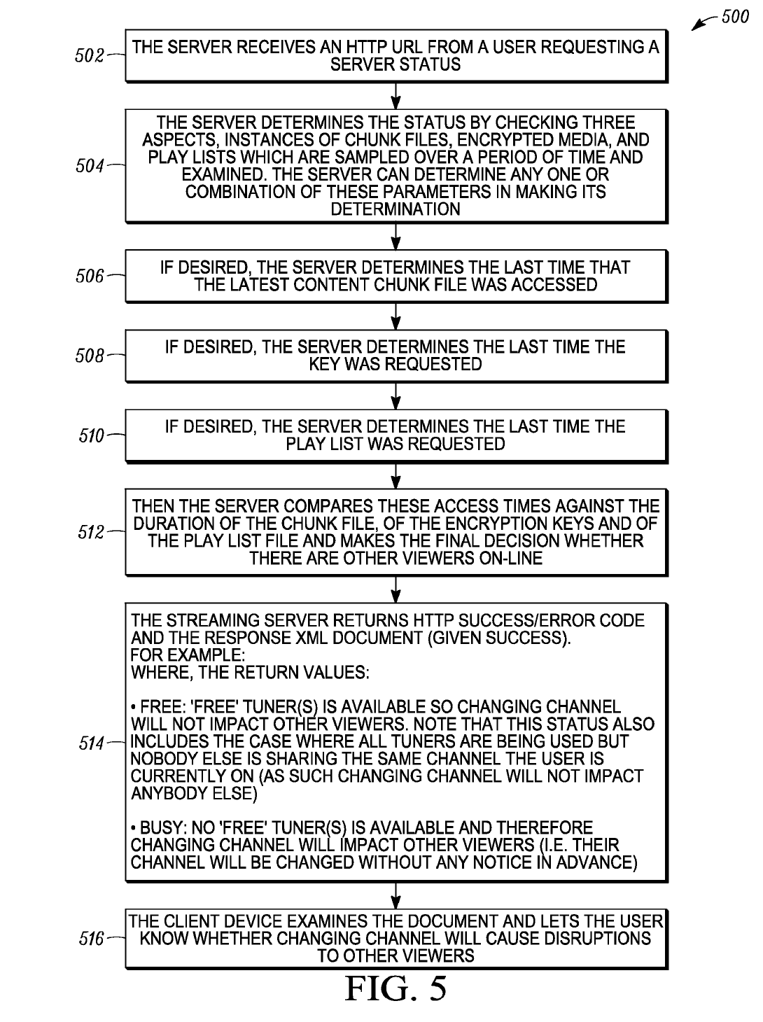

Example method 500 is described with reference to FIG. 5 in accordance with one or more embodiments of an object model for domain-based content mobility. Generally, any of the services, functions, methods, procedures, components, and modules described herein can be implemented using software, firmware, hardware (e.g., fixed logic circuitry), manual processing, or any combination thereof. A software implementation represents program code that performs specified tasks when executed by a computer processor. The example methods may be described in the general context of computer-executable instructions, which can include software, applications, routines, programs, objects, components, data structures, procedures, modules, functions, and the like. The program code can be stored in one or more computer-readable storage media devices, both local and/or remote to a computer processor. The methods may also be practiced in a distributed computing environment by multiple computer devices. Further, the features described herein are platform-independent and can be implemented on a variety of computing platforms having a variety of processors.

FIG. 5 illustrates example method(s) 500 of an object model for domain-based content mobility, and is generally described with reference to embodiments of a domain controller instantiated from the domain class. The order in which the method blocks are described are not intended to be construed as a limitation, and any number or combination of the described method blocks can be combined in any order to implement a method, or an alternate method.

A method 500 is shown below and illustrates a client device query to a streaming server for its status, which will indicate whether changing channel will impact other users. Defined herein are an XML schema, a URL and a HTTP response message that enables the client device to obtain the status of the streaming server.

A domain controller has been implemented from a domain class in a client object model architecture. For example, the client object model architecture 300 (FIG. 3) includes a domain controller that is instantiated from the domain class 302. A domain is discovered that has a media server, which wirelessly communicates media content to a mobile client device for playback of the media content on the mobile client device. For example, the domain controller (e.g., of the domain class 302) in the client object model architecture 300 discovers the domain that includes the media server 126, which wirelessly communicates media content to the client device 128 via the router 130 for playback of the media content on the mobile client device.

At block 502, the server receives an HTTP URL from a user requesting a server status. For example:

| | |
|---|---|
| URI | http://{streaming-server}/tuner/status |
| METHODS | GET |
| RETURN VALUES | 200 OK, 404 (status unknown) |

GET http://{streaming-server}/tuner/status

At block 504, the server determines the status by checking three aspects, instances of chunk files, encrypted media, and play lists which are sampled over a period of time and examined. The server can determine any one or combination of these parameters in making its determination. In one embodiment, the time period is ten minutes, but the time period can be any reasonable period, for instance, based on the duration of a normal chunk file.

At block 506, if desired, the server determines the last time that the latest content chunk file was accessed.

At block 508, if desired, the server determines the last time that the key was requested.

At block 510, if desired, the server determines the when was the last time the play list was requested.

At block 512, then the server compares these access times against the duration of the chunk file, of the encryption keys and of the play list file and makes the final decision whether there are other viewers on-line.

At block 514 the streaming server returns HTTP success/error code and the response XML document (given success). For example:

RETURNS
<?xml version=“1.0” encoding=“UTF-8”?>
<tuner>
<status>BUSY</status>
</tuner>

where, the Return Values:
FREE: ‘free’ tuner(s) is available so changing channel will NOT impact other viewers. Note that this status also includes the case where all tuners are being used but nobody else is sharing the same channel the user is currently on (as such changing channel will not impact anybody else).
BUSY: no ‘free’ tuner(s) is available and therefore changing channel will impact other viewers (i.e. their channel will be changed without any notice in advance).

At block 516, the client device examines the document and lets the user know whether changing channel will cause disruptions to other viewers.

The method examines the last access time of the streaming elements (i.e., the chunk files, the key and the playlist files) to decide the potential impacts or no impacts. As such, the client application can make an informed decision for channel changes.

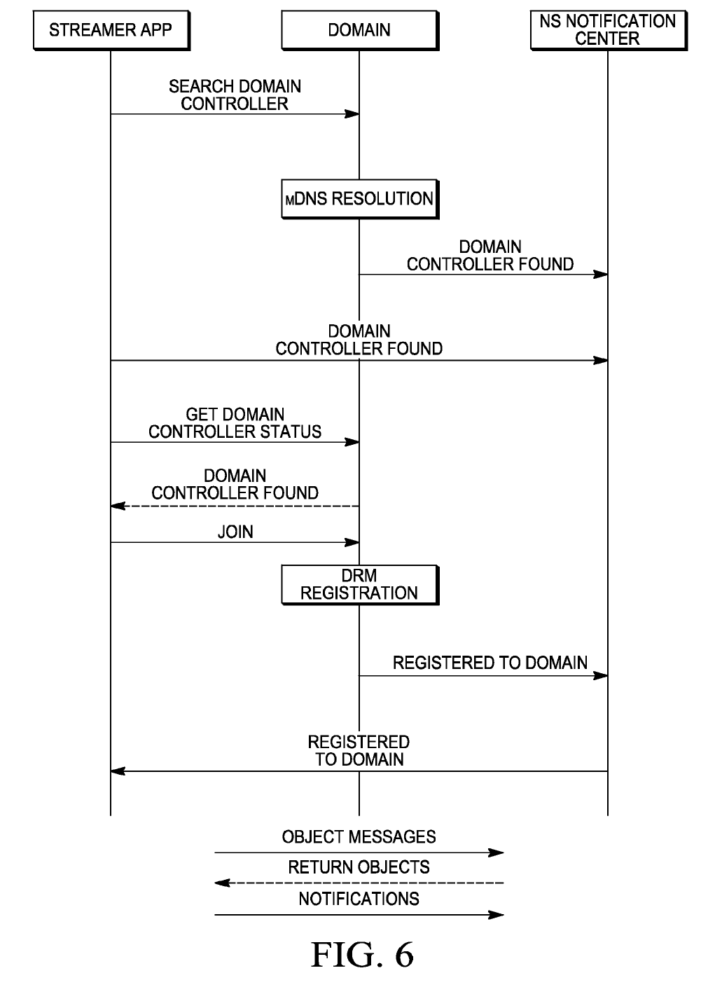

FIGS. 6-9 illustrate respective API object model communication sequence diagrams between the components, devices, and entities in a client object model domain system in accordance with one or more embodiments of an object model for domain-based content mobility. The client object model architecture 300 described with reference to FIG. 3 includes the set of classes, the associated methods, and shows the relationships between the classes. The client object model includes the set of APIs to implement the object model, and the object model communication sequence diagrams shown in FIGS. 6-9 illustrate the object model APIs. Further, a Representational State Transfer (REST) software architecture is described below as the REST API specification that includes the API definitions of the object model classes that are described with reference to the client object model architecture 300 shown in FIG. 3.

FIG. 6 illustrates an example of a Register to Domain communication sequence between a StreamerApp (also referred to as a streamer client application, such as implemented on the client device 128), a domain, and an NS notification center to register a client device to the client object model domain. The domain is an example of the domain class 302 described with reference to FIG. 3, from which a domain controller can be instantiated for overall control of the object model. In the example communication sequence shown in FIG. 6, the client device application initiates a search domain controller object message, and the domain utilizes Multicast DNS (mDNS) that allows the client device application to discover the domain, as described above with reference to the media server 126 shown in FIG. 1, and as described below with reference to Mover Discovery and Name Resolution in the REST API specification.

The domain communicates a domain controller found to NS notification center, which communicates a domain controller found notification back to the client device application. The client device application communicates a get domain controller status message, and the domain returns a domain controller found object. The client device application then communicates a join object message to the domain, which utilizes DRM registration to register the client device to the domain, and communicates a registered to domain notification to the NS notification center. The NS notification center returns a registered to domain notification to the client device application. The client device application then communicates a get RCS hostnames object message to the domain, which returns the RCS hostnames object to the client device application.

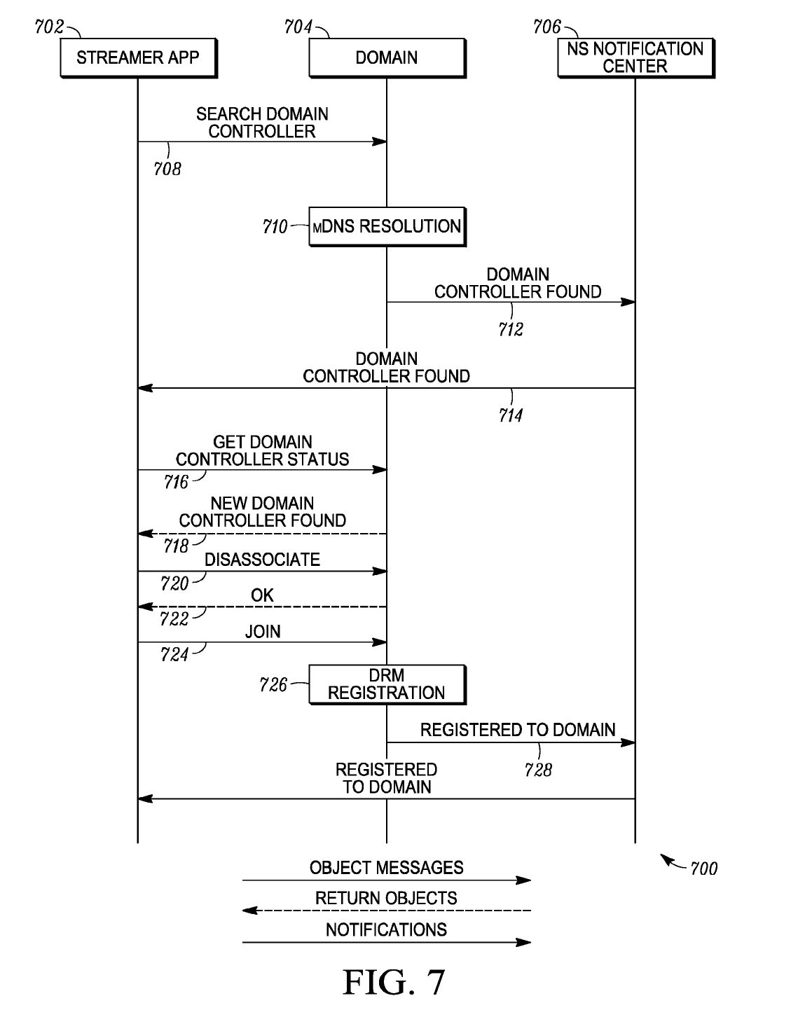

FIG. 7 illustrates an example of a Register to a New Domain communication sequence 700 between a client device application 702, a domain 704, and an NS notification center 706 to register a client device to a new domain, such as the client object model domain 302 described with reference to FIG. 3. The client device application 702 can be implemented on the client device 128 as described with reference to FIG. 1. In the example communication sequence 700, the client device application 702 initiates a search domain controller object message 708, and the domain 704 utilizes Multicast DNS (mDNS) resolution 710 that allows the client device application to discover the domain, as described above with reference to the media server 126 shown in FIG. 1, and as described below with reference to Media Server/Streamer Discovery and Name Resolution in the REST API specification.

The domain 704 communicates a domain controller found notification 712 to the NS notification center 706, which communicates a domain controller found notification 714 back to the client device application 702. The client device application communicates a get domain controller status message 716, and the domain returns a new domain controller found object 718. The client device application can communicate a disassociate object message 720 to the domain, and receive an ok return object 722 from the domain. The client device application then communicates a join object message 724 to the domain, which utilizes DRM registration 726 to register the client device to the new domain, and communicates a registered to domain notification 728 to the NS notification center. The NS notification center returns a registered to domain notification to the client device application. The client device application then communicates a get RCS hostnames object message to the domain, which returns the RCS hostnames object 734 to the client device application.

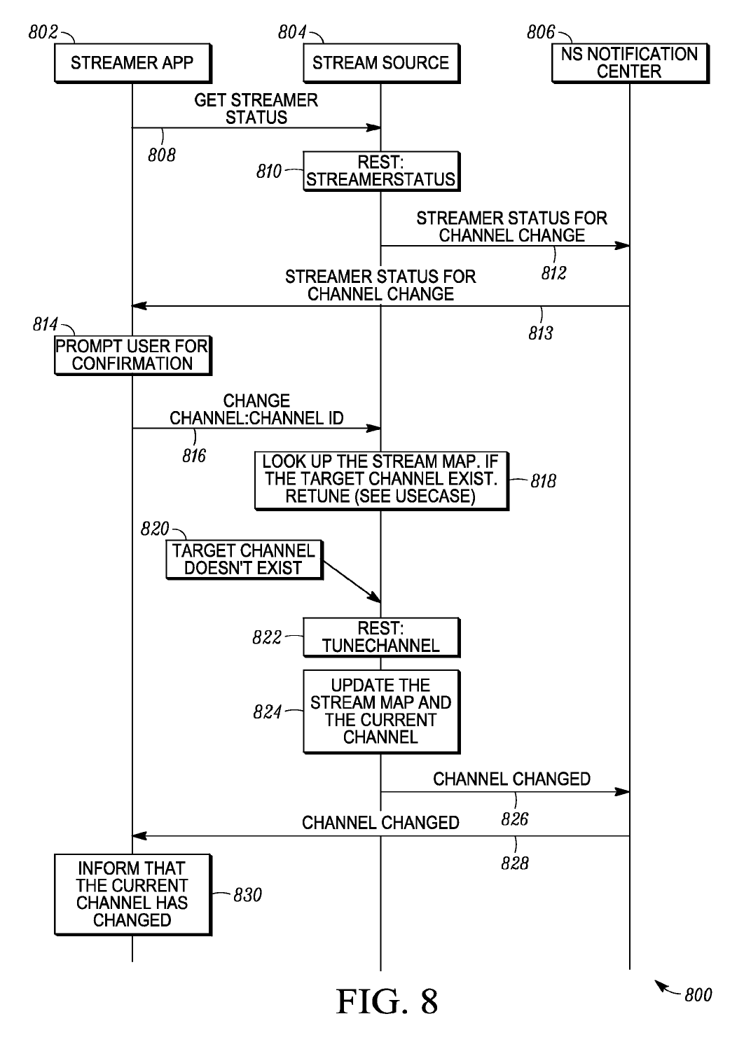

FIG. 8 illustrates an example of Command Channel Change communication sequence 800 between a client device app (e.g. StreamerApp) 802, a media server (e.g. StreamSource) 804, and an NS notification center 806. The media server 804 is an example of the media server 126, and the client device application 802 can be implemented on the client device 128 as described with reference to FIG. 1.

In the example communication sequence 800, the client device application 802 sends a getStreamerStatus message 808 to a Stream Source 804 at which REST::streamerstatus 810 is performed. A StreamerStatusForChannelChange 812 notification is sent to NSNotification Center 806 and the notification 813 is provided to the Streamer App 802. The user may be prompted for confirmation. 814 A changeChannel:channelID message 816 is sent from the Streamer App 802 to the Stream Source 804. The target channel is looked up on the stream map and a Retune command is performed if it is found. 818. If the channel is not found 820, a REST::tunechannel process 822 is formed and the stream map is updated 824. The channelChanged notification 826 is provided to the NSNotification 806 center and 828 to the Streamer App, 802 which may inform the user 830. The getStreamerStatus method 808 is optional. It gives the app an opportunity to confirm but is not required for commanding channel changes. However, as a general rule, the streamer will execute channel change requests one request at a time; and therefore, if a second request comes in before the current change is completed, the streamer will ABORT the current one and switch to the second request.

When a user tries to change channel in a live TV streaming application based on HTTP Live Streaming, there is a chance that it might cause disruptions for other viewers who are watching the channel. Accordingly, a method is disclosed herein to assist the user to make an informed decision before the channel is changed.

The disclosure uses the mDNS protocol: http://files.multicastdns.org/draft-cheshire-dnsext-multicastdns.txt as a notification mechanism.

A software algorithm that handles the unsolicitated channel changes may include a main workflow as follows:

1. A channel change has occurred in the streaming server.

2. The server generates an mDNS notification, specifying the binding between the channel and the tuner (given multiple tuners exist).

3. The client device receives the notification.

4. The client device checks new the channel binding against its internal channel table, and handles three possible scenarios:
a) If the current channel stays on the same tuner, then do nothing.
b) If the current channel moves to another tuner, then acquire the new tuner manifest and tune into it.
c) If the current channel disappears and the tuner that the client device is tuned into has a new channel number, then inform the user interface of the new channel number.

The scheme above handles the unsolicited channel changes via a local channel table and uses it to compare against the new channel layout to do what is necessary based on the result of the comparison.

In another embodiment, an example of unsolicited channel change—with mDNS notifications communication sequence between a client device app (e.g. StreamerApp), a media server (e.g. StreamSource), an NS notification center, a domain, and a Bonjour interface can be illustrated. As shown, a Bonjour Interface monitors the messages sent from Media Server and sends a TXTRecordUpdate notification to the Domain which checks the Update type to confirm that the message is a channel change operation. A ChannelUpdate notification is sent from the Domain to the NSNotification center and ChannelUpdate is sent to Stream Source. In one scenario (1), the current channel stays on the same tuner, and a Do Nothing command is issued. In another scenario (2), the current channel is on a different tuner, then Retune. In yet another scenario (3), the current channel cannot be found on any tuner, then let the app know the channel has changed. The Stream Source sends out a ChannelChange notification and the NSNotification center sends ChannelChange notification to the Streamer App. The Streamer App. may get the channel ID and inform that the current channel has changed. Note that this sequence covers the emergency, forced channel change scenario. All the streamer need to do is to put the forced channel on all the tuners. Also note for the emergency use case, there are no client software or app changes because the media server merely shuffles in the emergency service content onto the existing channels. In a scenario 3, the app will first receive the ChannelChange notification; however, the app can exercise parental control if it chooses to or the app could also go through channel playback.

FIG. 9 illustrates various components of an example electronic device 1000 that can be implemented as any device described with reference to any of the previous FIGS. 1-8. In embodiments, the electronic device may be implemented as a media server or a client device, such as described with reference to FIG. 1. Alternatively or in addition, the electronic device may be implemented in any form of device that can receive and playback streaming video content, such as any one or combination of a communication, computer, media playback, gaming, entertainment, mobile phone, and/or tablet computing device.

The electronic device 1000 includes communication transceivers 1002 that enable wired and/or wireless communication of device data 1004, such as received data, data that is being received, data scheduled for broadcast, data packets of the data, etc. Example transceivers include wireless personal area network (WPAN) radios compliant with various IEEE 802.15 (Bluetooth™) standards, wireless local area network (WEAN) radios compliant with any of the various IEEE 802.11 (WiFi™) standards, wireless wide area network (WWAN) radios for cellular telephony, wireless metropolitan area network (WMAN) radios compliant with various IEEE 802.15 (WiMAX™) standards, and wired local area network (LAN) Ethernet transceivers.

The electronic device 1000 may also include one or more data input ports 1006 via which any type of data, media content, and/or inputs can be received, such as user-selectable inputs, messages, music, television content, recorded video content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the electronic device to components, peripherals, or accessories such as microphones and/or cameras.

The electronic device 1000 includes one or more processors 1008 (e.g., any of microprocessors, controllers, and the like), which process computer-executable instructions to control operation of the device. Alternatively or in addition, the electronic device can be implemented with any one or combination of software, hardware, firmware, or fixed logic circuitry that is implemented in connection with processing and control circuits, which are generally identified at 1010. Although not shown, the electronic device can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

The electronic device 1000 also includes one or more memory devices 1012 that enable data storage, examples of which include random access memory (RAM), non-volatile memory (e.g., read-only memory (ROM), flash memory, EPROM, EEPROM, etc.), and a disk storage device. A disk storage device may be implemented as any type of magnetic or optical storage device, such as a hard disk drive, a recordable and/or rewriteable disc, any type of a digital versatile disc (DVD), and the like. The electronic device 1000 may also include a mass storage media device.

A memory device 1012 provides data storage mechanisms to store the device data 1004, other types of information and/or data, and various device applications 1014 (e.g., software applications). For example, an operating system 1016 can be maintained as software instructions within a memory device and executed on the processors 1008. The device applications may also include a device manager, such as any form of a control application, software application, signal-processing and control module, code that is native to a particular device, a hardware abstraction layer for a particular device, and so on. The electronic device may also include a proxy application 1018 and a media player 1020, such as for a client device. The electronic device also includes a client object model architecture 1022 that can be implemented in any one or combination of software, hardware, firmware, or the fixed logic circuitry to implement embodiments of an object model for domain-based content mobility.

The electronic device 1000 also includes an audio and/or video processing system 1024 that generates audio data for an audio system 1026 and/or generates display data for a display system 1028. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 1030. In implementations, the audio system and/or the display system are integrated components of the example electronic device.

REST API Spec

An API specification is described herein as a Representational State Transfer (REST) software architecture. The REST API specification includes the API definitions of the object model classes that are described with reference to the client object model architecture 300 shown in FIG. 3. The REST API specification includes Resource URIs (uniform resource identifiers), which are implemented as:

```
Content Directory URI: (refers to programs that are available for download)
  http://{portal-server}/programs/contentdirectory
Program Metadata URI:
  http://{portal-server}/programs/{program-id}
Set transcode mode:
  http://{content-server}/content/settranscodemode?m=<CO/NONE>
Transcode Priority URI:
  http://{content-server}/content/{program-id}
Domain URI:
  http://{domain-server}/domain/{device-id}
Content Control Profile URI:
  http://{domain-server}/domain/contentControlProtile
Channel Tuning URI:
http://{streaming-server}/tuner/status
http://{streaming-server}/tuner/tuneshanne?c=<channel-ID&m=<mode>
http://{streaming-server}/tuner/channellist
```

Mover Discovery and Name Resolution

As noted above, the media server is also referred to herein as the Mover. The Mover Runtime environment and software architecture are shown in FIGS. 1 and 2. In an embodiment of a Mover application, the Mover serves as the portal server, the content server, as well as the domain server. Prior to launching any of the Resource URIs above, the client device discovers the Mover's server name that can be used to resolve to the Mover IP address, as described with reference to FIG. 6. The Mover supports the Multicast DNS (mDNS) for the name discovery and IP address resolution mechanism. The mDNS protocol lets the client device discover the Mover by obtaining its fully-qualified name (FQN) and its IP address. First the client multicasts a query looking for the Mover, and then the Mover's mDNS server responds to the request by providing the FQN and the IP address. With that, the client device builds its name resolution table, and when the Mover's FQN is used in the HTTP URI, the message will be sent to the Mover correctly.

Mover Status Update Notification

The mDNS protocol also supports event notifications. The Mover uses this mechanism to notify the client devices when the status changes in some way. The scope of status updates includes the default ratings PIN, the default rating ceiling, the default content advisory settings and channel blocks, the content metadata and repository, and a notification that user intervention is required via the Mover local Web configuration page (for example, that flash memory needs configuration). Note that the ratings related status data is protected. If ratings information of content information has changed, the client devices would normally launch the relevant resource URI.

Method Overview

Methods Include:

| Resource (next line): | Method | Returns | HTTP Return Codes |
|---|---|---|---|
| http://{portal-server}/programs/{program-id} | GET | PROGRAM metadata | 200 (OK), 404 |
| http://{portal-server}/programs/contentdirectory | GET | Content Directory List | 200 (OK), 404 |
| http://{content-server}/content/settranscodemode | POST | | 200 (OK), 404 |
| http://{content-server}/content/{program-id} | GET | | 200 (OK), 404, 405 |
| http://{domain-server}/domain/{deyice-id} | PUT | | 200 (OK), 401, 402, 403, 404 |
| http://{domain-server}/domain/{device-id} | DELETE | | 200 (OK), 404 |
| http://{domain-server}/domain/contentControlProfile | GET | A protected data blob | 200 (OK), 404 |
| | | describing the subject | |
| http://{ streaming-server}/tuner/status } | GET | | 200 (OK), 404 |
| http://{streaming-server}/tuner/tuneshanne?c=<channel-ID&m=<mode> | GET | | 200 (OK), 404 |
| http://{streaming-server}/tuner/channellist | GET | | 200 (OK), 404 |

Representation MIME Types

The following mime types are used for resource representation:

text/xml for metadata representations;
video/mpeg for video;
application/vnd.motorola.iprm for IPRM encrypted video; and
application/x-dtcp1 for DTCP encrypted video.

### ABBREVIATIONS USED

The following abbreviations are used:

{portal-server} Portal Server that implements the RESTful web service.

{content-server} Server for accessing content payload.

{domain-server} The server that enforces domain control rules.

{streaming-server} The server that provides HIS streaming.

Content Directory

Description: The content directory URI provides the list of programs that are currently in the media server database.

Sequence Number: The sequenceNumber element in the response message indicates to the client application whether the content list is changed from last time. A new sequence number indicates a change.

Transcoding Status: The status element indicates one of the four transcoding status: ready (for download or streaming), being processed (i.e. being transcoded), pending (for processing) and not available (e.g. ratings blocked, or bad content). Note that all directory items returned in a response that are marked pending are returned in transcoder queue (priority) order, with the first listing at the highest priority, meaning, next to be transcoded.

Content Usage: The usageAllowed element signals what kinds of use cases are allowed for the content. The table below specifies mapping between the usageAllowed metadata value and the client use cases allowed:

| <usageAllowed> | Use Case(s) allowed |
|---|---|
| stream | Streaming |
| move | Streaming, Move |
| copy | Streaming, Copy |

Content Ratings: The content ratings values are listed below. A program can assume one and only one rating. Note that these values are defined by the MPAA and the TV Parental Guidelines Monitoring Board. The content rating values include Not Rated, TV-Y, TV-Y7, TV-G, G, TV-PG, PG, PG-13, TV-14, TV-MA, R, NC-17, and Adult.

Parental Control Categories: The values for parental control categories are listed below. A program can assume one or multiple categories. Note that these values are defined by the TV Parental Guidelines Monitoring Board. The parental control categories values include Adult Situation, Brief Nudity, Sexual Situations, Rape, Nudity, Strong Sexual, Language, Strong Language, Graphic Language, Explicit Language, Fantasy Violence, Mild Violence, Violence, and Graphic Violence.

URI and Defined Methods:

| | |
|---|---|
| URI | http://{portal-server}/programs/contentdirectory |
| METHODS | GET |
| RETURN VALUES | 200 OK & XML (program list), 404 (Not Found) |

GET Implementation:

```
GET http://{portal-server}/programs/contentdirectory
RETURNS:  {list of programs}
<?xml version=“1.0” encoding=“UTE-8”?>
<moverContent>
<moverProtocolVersion>1.0</moverProtocolVersion>
<sequenceNumber>102</sequenceNumber>
  <program channel=“53044” ...>... </program >
  ...
</moverContent>
```

The example below shows a list of two content items, one with program-id TOD55341 and the other with TOD55342. The first program comes with two content URLs, a type 1 and a type 2. The variant attribute corresponds to the device type (see the device registration for details). The client application is recommended to use the URL that matches its device type or the content playback might fail or present a suboptimal experience. The icon element specifies where to get the program thumbnail. There are two icon elements in the first program, intended to match the best usage for a type 1 and type 2 device respectively. The height element and the width element show example values.

```
GET http://{portal-server}/programs/contentdirectory
RETURNS:
<?xml version=“1.0” encoding=“UTF-8”?>
<moverContent>
<moverProtocolVersion>1.0</moverProtocolVersion>
<sequenceNumber>102</sequenceNumber>
<program channel=“53044” channelName=“NBC” program-id=“TOD55341” showtype=“Series”
start=“2009-05-29T18:01:00Z” stop=“2009-05 29T19:00:00Z”>
<seriesName lang=“”>Northern Exposure</seriesName>
<programName lang=“”>A Wing and a Prayer</programName>
<status>ready</status>
<usageAllowed>stream</usageAllowed>
<rating>PG</rating>
<parentalControlCategory>
  <contentCategory>Language</contentCategory>
</parentalControlCategory>
<icon height=“32” src=“http://192.168.4.12:7001/portalaccess/images/a ptn_logo_94x90.jpg”
width=“32”/>
< icon height=“48” src=“http://192.168.4.12:7001/portalaccess/images/a ptn_logo_194x190.jpg”
width=“48”/>
<content-url href=“http://192.168.4.12/content/TOD55341.mp4” variant=“type 1”
protectionType=“IPRM” filesize=“12345678” contentID=“xyz001” />
<content-url href=“http://192.168.4.12/content/TOD55341-1.mp4” variant=“type 2”
rotectionType=“IPRM” filesize=“12345678” contentID=“xyz001” />
</program>
<program channel=“53044” channelName=“NBC” program-id=“TOD55342” showtype=“Series”
start=“2009-05-29T19:01:00Z” stop=“2009-05-29T20:00:00Z”>
<seriesName lang=“”>Chuck</seriesName>
<programName lang=“”>The Missing Old Man</programName>
<status>pending</status>
<usageAllowed>copy</usageAllowed>
<rating>R</rating>
<parentalControlCategory>
  <contentCategory>Violence</contentCategory>
  <contentCategory>Language</contentCategory>
  <contentCategory>Nudity</contentCategory>
</parentalControlCategory>
<icon height=“32” src=“http://192.168.4.12:7001/portalaccess/images/a ptn_logo_94x90.jpg”
width=“32”/>
<content-url href=“http://content-server/content/TOD55342” variant=“type 1”
protectionType=“DTCP-IP” filesize=“12345678” contentID=“xyz002” />
</program>
</moverContent>
```

Program Metadata

Description: The program metadata URI is a pre-defined URI which can be used to download the detailed program representation of any program using the program-id. This is further described above with reference to the content program object 1006 (FIG. 10) that references the REST API program metadata URI 1014, which can be used to download the detailed program representation of any program using the program-id. The URI and Defined Methods:

| | |
|---|---|
| URI | http://{portal-server}/programs/{program-id} |
| METHODS | GET |
| RETURN VALUES | 200 OK & XML (program metadata), 404 (Not |
| | Found), |

GET Implementation: See Example. Two examples are shown below. Example 1 shows the case where the metadata is protected and base64 encoded, and the second example shows clear metadata. In order to produce the clear metadata, the client app must use the <protectionType> and apply the right scheme to it.

GET http://{portal-seryer}/programs/ TOD55341
RETURNS: (metadata for a single program)
<?xml yersion=“1.0” encoding=“UTF-8”?>
<moverContent>
<moverProtocolVersion>1.0</moverProtocolVersion>
<protectedMetadata>
{a base64 encoded binary data blob}
</protectedMetadata>
</moverContent>

GET http://{portal-server}/programs/ TOD55341
RETURNS: (metadata for a single program)
<?xml version=“1.0” encoding=“UTF-8”?>
<moverContent>
<moverProtocolVersion>1.0</moverProtocolVersion>
<program channel=“53044” channelName=“NBC” program-id=“TOD55341” showType=“Series”
start=“2009-05-29T18:01:00Z” stop=“2009-05-29T19:00:00Z” closeCaptioned=“true”>
<seriesName lang=“”>Northern Exposure</seriesName>
<desc lang=“”>Maggie hires Maurice to help her build an ultralight, then fires him when he gets
bossy; Ed betrays Ruth-Annes confidence.</desc>
<credits>
<actor>Rob</actor>
<actor>Steve</actor>
<director>Moha n</director>
<director>Wendell</director>
<producer>Dev</producer>
</credits>
<audio present=“yes” stereo=“yes” />
<episode-num system=“xmltv_ns”>77720</episode-num>
</program>
</moverContent>

Set Transcode Mode

URI and Defined Methods. Description: This URI is a command to the content server, indicating whether it should transcode the Copy Once content or not, in an automatic fashion.

| | |
|---|---|
| URI | http://{content-server}/content/settranscodemode?m= |
| | <CO/NO> |
| METHODS | POST |
| RETURN | 200 OK, 404 (fail) |
| VALUES | |

GET Implementation: Parameter CO: Transcode Copy Once content automatically. Parameter NO: Do NOT transcode Copy Once content automatically; rather, transcode each such content item on request.

GET http://{content-server}/content/transcodemode?m=<CO/NO>
RETURNS:

Transcode Priority

URI and Defined Methods:

| | |
|---|---|
| URI | http://{content-server}/content/{program-id} |
| METHODS | GET |
| RETURN VALUES | 200 (Priority Raised), 404 (Not Found), 405 |
| | (Failed to raise Priority) |

Return Value Notes: The return value 200 indicates the priority of the requested program has been raised. The return value 404 indicates program not found. The return value 405 indicates the priority of the requested program cannot be raised. GET Implementation:

GET http://{content-server}/content/{program-id}
RETURNS:

Device Registration

Descriptions: To register a new client device to the Mover domain, a PUT message is sent to the ‘domain’ URI with the device-id appended to the end. The body of the PUT method includes the data elements defined below. URI and Defined Methods:

| | |
|---|---|
| URI | http://{domain-server}/domain/{device-id} |
| METHODS | PUT |
| RETURN | 200 OK, 401 (III-formed body), 402 (Duplicate device ID), |
| VALUES | 403 (protection type not supported), 404 (Exceeds |
| | maximum number of devices allowed), |

PUT Implementation

PUT http://{domain-server}/domain/{device-id}
<?xml version=″1.0″ encoding=″UTF-8″?>
<clientDevice>
<deviceID>{device-id}</deviceID>
<deviceName>{device-name}</deviceName>
<deviceType>{device-type}</deviceType>
<protectionType>{device-protection-type}</protectionType>
</clientDevice>

PUT Data Elements:
{device-id}: The device ID is a base64-encoded binary string that uniquely identifies the client device according to its DRM certificate. For a device with IPRM certificates, it has a 48-bit Host ID, and for a device with DTCP certificates, it has a 40-bit Device ID.
{device-name}: The device name is a user-friendly string, determined by the client's user. All printable characters and blank spaces are allowed.
{device-type}: The device type field signals the type of user device, i.e., type 1 or type 2. A type 1 device would support half-VGA resolution H.264 baseline profile video coding, AAC audio coding, and an MP4 file container. A type 2 device would support type 1 content as well as VGA resolution H.264 main profile video coding, AAC audio coding, and an MP4 file container. In either type, the MP4 file is an ISO/IEC 14496 standard part 14 format, further qualified to guarantee that the moov box is located before any mdat box, and there will be only one mdat box in the whole content file. This qualification allows progressive download support.
{device-protection-type}: The device protection type signals the type of security being supported by the device, e.g., IPRM or DTCP-IP.

### Example:

PUT http://{domain-server}/domain/{aBase64EncodedString}
<?xml version=″1.0″ encoding=″UTF-8″?>
<clientDevice>
<deviceID>{aBase64EncodedString}</deviceID>
<deviceName>Library PC</deviceName>
<deviceType>type 1</deviceType>
<protectionType>DTCP-IP</protectionType>
</clientDevice>

Device De-Registration

Description: To de-register a client device from the Mover domain, a DELETE message is sent to the ‘domain’ URI with the device-id appended to the end. URI and Defined Methods:

| | |
|---|---|
| URI | http://{domain-server}/domain/{device-id} |
| METHODS | DELETE |
| RETURN VALUES | 200 OK, 404 (Not Found) |

DELETE Implementation—Example

DELETE http://{domain-server}/domain/{aBase64EncodedString}

Content Control Profile

Description: The Content Control Profile URI retrieves the Mover content control profile, including the rating's ceiling, the content advisory information, the PIN and the channel block information. URI and Defined Methods:

| | |
|---|---|
| URI | http://{domain-server}/domain/ |
| | contentControlProfile |
| METHODS | GET |
| RETURN VALUES | 200 OK & XML (status metadata), 404 (Not Found) |

Examples: The example below shows a GET request and the response XML metadata. Note that the metadata is encrypted with a secret key and the client needs to decrypt it first and then parse out the detailed data items. The <profileProtectionType> data item signals what kind of protection scheme is applied.

| GET http://{domain-server}/domain/contentControlProfile | |
|---|---|
| RETURNS: | (protected metadata of the Mover status update) |

```
<?xml version=″1.0″ encoding=″UTF-8″?>
<contentControlProfile>
  <moverProtocolVersion>1.0</moverProtocolVersion>
  <sequenceNumber>2475</sequenceNumber>
  <profileProtectionType>PPT-1</profileProtectionType >
  <profileData>
    {a base64 encoded binary data blob}
  </profileData>
</contentControlProfile>
```

Status Metadata Examples: The example below shows a set of content control profile after it's been unscrambled.

```
<?xml version=“1.0” encoding=“UTF-8”?>
<contentControlProfile>
  <moverProtocolVersion>1.0</moverProtocolVersion>
  <sequenceNumber>2475</sequenceNumber>
  <PIN>1234</PIN>
  <contentBlocking>
    <rating>PG-13</rating>
    <parentalControlCategory>
      <contentCategory>Violence</contentCategory>
      <contentCategory>Rape</contentCategory>
      <contentCategory>Language</contentCategory>
      <contentCategory>Nudity</contentCategory>
  </parentalControlCategory>
  <channelBlock>
    <channel>73</channel>
    <channel>103</channel>
    <channel>765</channel>
  </channelBlock>
</contentBlocking>
</contentControlProfile>
```

### 2. Channel Tuning

Description: Channel Tuning URI's provides three API's to let the client applications to learn the potential impacts of channel changes, to command a channel change and to get the channel mappings.

### URI and Defined Methods

### Tuner Status

This URI returns the status of the tuner in a set of pre-defined values.

| | |
|---|---|
| URI | http://{streaming-server}/tuner/status |
| METHODS | GET |
| RETURN VALUES | 200 OK, 404 (status unknown) |

```
GET http://{streaming-server}/tuner/status
RETURNS
<?xml version=″1.0″ encoding=″UTF-8″?>
<tuner>
  <status>BUSY</status>
</tuner>
Return Values
  FREE: ‘free’ tuner(s) is available so changing channel will NOT impact
  other viewers. Note that this status also includes the case where all
  tuners are being used but nobody else is sharing the same channel the
  user is currently on (as such changing channel will not impact anybody
  else).
  BUSY: no ‘free’ tuner(s) is available and therefore changing channel
  will impact other viewers (i.e. their channel will be changed without any
  notice in advance).
```

### Tune Channel

This URI returns the playlist URL of the target channel for the mode of interest.

| | |
|---|---|
| URI | http://{streaming-server}/tuner/tunechannel?c= |
| | <channel-ID>&m=<mode> |
| METHODS | GET |
| PARAMETERS | 1. The ID of the target channel. |
| | 2. The mode, i.e. the type of the device (see [ [symbol] ]) |
| RETURN | 200 OK, 404 (No Signal), 405 (Not Authorized), 406 |
| VALUES | (No Such Channel) |

```
GET http://{streaming-server}/tuner/tunechannel?c=704&m=type1
RETURNS
<?xml version=″1.0″ encoding=″UTF-8″?>
<streamerContent>
  <channel number=″704″ name″NBC″>
  <tunerID>2</tunerID>
  <playlist-url>http://streamer.local/tuner/manifest/704.m3u8</playlist-url>
  <sourceID>2984</sourceID>
  </channel>
</streamerContent>
```

### Channel List

This URI returns the channel map of the streaming server.

| | |
|---|---|
| URI | http://{streaming-server}/tuner/channellist |
| METHODS | GET |
| RETURN VALUES | 200 OK, 404 (Not Found) |

| GET http://{streaming-server}/tuner/channellist | |
|---|---|
| RETURNS: | (protected metadata of the Mover status update) |

```
<?xml version=″1.0″ encoding=″UTF-8″?>
<channelList>
  <sequenceNumber>101</sequenceNumber>
  <channel number=″704″ name″NBC″/>
  <channel number=″705″ name=″ABC″/>
  <channel number=″706″ name=″CBS″/>
</channelList>
```

### XML Schemas

Content Directory Schema

Content Directory Schema

```
<?xml version=“1.0” encoding=“utf-8”?>
<xs:schema xmlns:xs=“http://www.w3.org/2001/XMLSchema”
xmlns:wmh=“http://www.wmhelp.com/2003/eGenerator” elementFormDefault=“qualified”>
  <xs:element name=“moverContent”>
    <xs:element name=“moverProtocolVersion” type=“xs:string”/>
    <xs:element name=“sequenceNumber” type=“xs:string”/>
    <xs:complexType>
      <xs:sequence>
        <xs:element ref=“program” maxOccurs=“unbounded”/>
      </xs:sequence>
    </xs:complexType>
  </xs:element>
  <xs:element name=“program”>
    <xs:complexType>
      <xs:attribute name=“channel” type=“xs:string” use=“required”/>
      <xs:attribute name=“channelName” type=“xs:string” use=“required”/>
      <xs:attribute name=“program-id” type=“xs:string” use=“required”/>
      <xs:attribute name=“showtype” type=“xs:string”/>
      <xs:attribute name=“start” type=“xs:string” use=“required”/>
      <xs:attribute name=“stop” type=“xs:string” use=“required”/>
      <xs:element ref=“seriesName”/>
      <xs:element ref=“programName”/>
      <xs:element ref=“status”/>
      <xs:element ref=“usageAllowed”/>
      <xs:element ref=“rating”/>
      <xs:element ref=“parentalCotrolCategory”/>
      <xs:sequence>
        <xs:element ref=“icon”/>
        <xs:element ref=“content-url” maxOccurs=“unbounded” minOccurs=“1”/>
      </xs:sequence>
    </xs:complexType>
  </xs:element>
  <xs:element name=“seriesName”>
    <xs:complexType>
      <xs:simpleContent>
        <xs:extension base=“xs:string”>
          <xs:attribute name=“lang” type=“xs:string” use=“required”/>
        </xs:extension>
      </xs:simpleContent>
    </xs:complexType>
  </xs:element>
  <xs:element name=“programName”>
    <xs:complexType>
      <xs:simpleContent>
        <xs:extension base=“xs:string”>
          <xs:attributename=“lang” type=“xs:string” use=“required”/>
        </xs:extension>
      </xs:simpleContent>
    </xs:complexType>
  </xs:element>
  <xs:element name=“icon”>
    <xs:complexType>
      <xs:attribute name=“height” type=“xs:string” use=“required”/>
      <xs:attribute name=“src” type=“xs:string” use=“required”/>
      <xs:attribute name=“width” type=“xs:string” use=“required”/>
    </xs:complexType>
  </xs:element>
  <xs:element name=“content-url”>
    <xs:complexType>
      <xs:attribute name=“href” type=“xs:string” use=“required”/>
      <xs:attribute name=“variant” type=“xs:string” use=“required”/>
      <xs:attribute name=“protectionType” type=“xs:string” use=“required”/>
        <xs:attribute name=“filesize” type=“xs:string”/>
        <xs:attribute name=“contentID” type=“xs:string”/>
    </xs:complexType>
  </xs:element>
  <xs:element name=“status”>
    <xs:simpleType>
      <xs:restriction base=“xs:string”>
        <xs:enumeration value=“ready”/>
        <xs:enumeration value=“being processed”/>
        <xs:enumeration value=“pending”/>
        <xs:enumeration value=“toBeSelected”/>
        <xs:enumeration value=“not available”/>
      </xs:restriction>
    </xs:simpleType>
  </xs:element>
  <xs:element name=“usageAllowed”/>
    <xs:simpleType>
      <xs:restriction base=“xs:string”>
        <xs:enumeration value=“stream”/>
        <xs:enumeration value=“copy”/>
        <xs:enumeration value=“move”/>
      </xs:restriction>
    </xs:simpleType>
  </xs:element>
  <xs:element name=“protectionType”/>
    <xs:simpleType>
      <xs:restriction base=“xs:string”>
        <xs:enumeration value=“IPRM”/>
        <xs:enumeration value=“DTCP-IP”/>
      </xs:restriction>
    </xs:simpleType>
  </xs:element>
  <xs:element name=“rating”>
    <xs:simpleType>
      <xs:restriction base=“xs:string”>
        <xs:enumeration value=“Not Rated”/>
        <xs:enumeration value=“TV-Y”/>
        <xs:enumeration value=“TV-Y7”/>
        <xs:enumeration value=“TV-G”/>
        <xs:enumeration value=“G”/>
        <xs:enumeration value=“TV-PG”/>
        <xs:enumeration value=“PG”/>
        <xs:enumeration value=“PG-13”/>
        <xs:enumeration value=“TV-14”/>
        <xs:enumeration value=“TV-MA”/>
        <xs:enumeration value=“R”/>
        <xs:enumeration value=“NC-17”/>
        <xs:enumeration value=“Adult”/>
      </xs:restriction>
    </xs:simpleType>
  </xs:element>
  <xs:element name=“contentCategory”>
    <xs:simpleType>
      <xs:restriction base=“xs:string”>
        <xs:enumeration value=“Adult Situation”/>
        <xs:enumeration value=“Brief Nudity”/>
        <xs:enumeration value=“Sexual Situations”/>
        <xs:enumeration value=“Rape”/>
        <xs:enumeration value=“Nudify”/>
        <xs:enumeration value=“Strong Sexual”/>
        <xs:enumeration value=“Language”/>
        <xs:enumeration value=“Strong La nguage”/>
        <xs:enumeration value=“Graphic Language”/>
        <xs:enumeration value=“Explicit Language”/>
        <xs:enumeration value=“Fantasy Violence”/>
        <xs:enumeration value=“Mild Violence”/>
        <xs:enumeration value=“Violence”/>
        <xs:enumeration value=“Graphic Violence”/>
      </xs:restriction>
    </xs:simpleType>
  </xs:element>
  <xs:element name=“parentalControlCategory”>
    <xs:complexType>
      <xs:sequence>
        <xs:element ref=“contentCategory” maxOccurs=“14”/>
      </xs:sequence>
    </xs:complexType>
  </xs:element>
</xs:schema>
```

Program Detail Schemas

Program Detail Schema - protected

```
<?xml version=″1.0″ encoding=″utf-8″?>
<xs:schema xmlns:xs=″http://www.w3.org/2001/XMLSchema″
xmlns:wmh=″http://www.wmhelp.com/2003/eGenerator″ elementFormDefault=″qualified″>
  <xs:element name=″moverContent″>
    <xs:element name=″moverProtocolVersion″ type=″xs:string″/>
    <xs:complexType>
      <xs:element name=″protectionType″ type=″xs:string″/>
      <xs:element name=″ protectedMetadata ″ type=″xs:base64Binary″/>
    </xs:complexType>
  </xs:element>
</xs:schema>
```

Program Detail Schema - clear

```
<?xml version=″1.0″ encoding=″utf-8″?>
<xs:schema xmlns:xs=″http://www.w3.org/2001/XMLSchema″
xmlns:wmh=″http://www.wmhelp.com/2003/eGenerator″ elementFormDefault=″qualified″>
  <xs:element name=″moverContent″>
    <xs:element name=″moverProtocolVersion″ type=″xs:string″/>
    <xs:complexType>
      <xs:element ref=″program″/>
    </xs:complexType>
  </xs:element>
  <xs:element name=″program″>
    <xs:complexType>
      <xs:attribute name=″channel″ type=″xs:string″ use=″required″/>
      <xs:attribute name=″channelName″ type=″xs:string″ use=″required″/>
      <xs:attribute name=″program-id″ type=″xs:string″ use=″required″/>
      <xs:attribute name=″showType″ type=″xs:string″ use=″required″/>
      <xs:attribute name=″start″ type=″xs:string″ use=″required″/>
      <xs:attribute name=″stop″ type=″xs:string″ use=″required″/>
      <xs:attribute name=″closeCaptioned″ type=″xs:string″ use=″required″/>
      <xs:element ref=″seriesName″/>
      <xs:element ref=″desc″/>
      <xs:element ref=″credits″/>
      <xs:element ref=″audio″/>
      <xs:element ref=″episode-num″/>
    </xs:complexType>
  </xs:element>
  <xs:element name=″seriesName″>
    <xs:complexType>
      <xs:simpleContent>
        <xs:extension base=″xs:string″>
          <xs:attribute name=″lang″ type=″xs:string″ use=″required″/>
        </xs:extension>
      </xs:simpleContent>
    </xs:complexType>
  </xs:element>
  <xs:element name=″desc″>
    <xs:complexType>
      <xs:simpleContent>
        <xs:extension base=″xs:string″>
          <xs:attribute name=″lang″ type=″xs:string″ use=″required″/>
        </xs:extension>
      </xs:simpleContent>
    </xs:complexType>
  </xs:element>
  <xs:element name=″credits″>
    <xs:complexType>
      <xs:sequence>
        <xs:element ref=″actor″/>
        <xs:element ref=″director″/>
        <xs:element ref=″producer″/>
      </xs:sequence>
    </xs:complexType>
  </xs:element>
  <xs:element name=″actor″ type=″xs:string″/>
  <xs:element name=″director″ type=″xs:string″/>
  <xs:element name=″producer″ type=″xs:string″/>
  <xs:element name=″audio″>
      <xs:complexType>
      <xs:attribute name=″present″ type=″xs:string″ use=″required″/>
      <xs:attribute name=″stereo″ type=″xs:string″ use=″required″/>
      </xs:complexType>
  </xs:element>
  <xs:element name=″episode-num″>
    <xs:complexType>
      <xs:simpleContent>
        <xs:extension base=″xs:string″>
          <xs:attribute name=″system″ type=″xs:string″ use=″required″/>
        <xs:extension>
      </xs:simpleContent>
    </xs:complexType>
  </xs:element>
</xs:schema>
```

Device Registration Schema

Device Registration Schema

```
<?xml version=“1.0” encoding=“utf-8”?>
<xs:schema xmlns:xs=“http://www.w3.org/2001/XMLSchema”
xmlns:wmh=“http://www.wmhelp.com/2003/eGenerator” elementFormDefault=“qualified”>
  <xs:element name=“clientDevice”>
    <xs:complexType>
      <xs:element name=“deviceID” type=“xs:base64Binary” use=“required”/>
      <xs:element name=“deviceName” type=“xs:string”/>
      <xs:element name=“deviceType”/>
        <xs:simpleType>
          <xs:restriction base=“xs:string”>
              <xs:restriction value=“type 1”/>
              <xs:restriction value=“type 2”/>
            </xs:restriction>
        </xs:simpleType>
      </xs:element>
      <xs:element ref=“protectionType”/>
    </xs:complexType>
  </xs:element>
</xs:schema>
```

Content Control Profile Schemas

Content Control Profile Schema - protected

```
<?xml version=“1.0” encoding=“utf-8”?>
<xs:schema xmlns:xs=“http://www.w3.org/2001/XMLSchema”
xmlns:wmh=“http://www.wmhelp.com/2003/eGenerator” elementFormDefault=“qualified”>
  <xs:element name=“contentControlProfile”>
    <xs:element name=“moverProtocolVersion” type=“xs:string”/>
    <xs:element name=“sequenceNumber” type=“xs:string”/>
    <xs:element name=“profileProtectionType” type=“xs:string”/>
    <xs:element name=“profileData” type=“xs:base64Binary”/>
  </xs:element>
</xs:schema>
```

Status Update Schema - clear

```
<?xml version=″1.0″ encoding=″utf-8″?>
<xs:schema xmlns:xs=″http://www.w3.org/2001/XMLSchema″
xmlns:wmh=″http://www.wmhelp.com/2003/eGenerator″ elementFormDefault=″qualified″>
  <xs:element name=″contentControlProfile″>
    <xs:element name=″moverProtocolVersion″ type=″xs:string″/>
    <xs:element name=″sequenceNumber″ type=″xs:string″/>
    <xs:complexType>
      <xs:sequence>
        <xs:element name=″PIN″ type=″xs:string″/>
        <xs:element ref=″contentBlocking″/>
      </xs:sequence>
    </xs:complexType>
  </xs:element>
  <xs:element name=″contentBlocking″>
    <xs:complexType>
      <xs:sequence>
        <xs:element ref=″rating″/>
        <xs:element ref=″parentalControlCategory″/>
        <xs:element ref=″channelBlock″/>
      </xs:sequence>
    </xs:complexType>
  </xs:element>
  <xs:element name=″channelBlock″>
    <xs:complexType>
      <xs:sequence>
        <xs:element name=″channel″ type=″xs:string″ maxOccurs=″unbounded″/>
      </xs:sequence>
    </xs:complexType>
  </element>
</xs:schema>
```

Channel Schema

Tuner Status

```
<?xml version=″1.0″ encoding=″utf-8″?>
<xs:schema xmlns:xs=″http://www.w3.org/2001/XMLSchema″
xmlns:wmh=″http://www.wmhelp.com/2003/eGenerator″ elementFormDefault=″qualified″>
<xs:element name=″tuner″>
  <xs:element name=″status″>
    <xs:simpleType>
      <xs:restriction base=″xs:string″>
        <xs:enumeration value=″FREE″/>
        <xs:enumeration value=″BUSY″/>
      </xs:restriction>
    </xs:simpleType>
  </xs:element>
</xs:element>
</xs:schema>
```

Tune Channel

```
<?xml version=″1.0″ encoding=″utf-8″?>
<xs:schema xmlns:xs=″http://www.w3.org/2001/XMLSchema″
<xmlns:wmh=″http://www.wmhelp.com/2003/eGenerator″ elementFormDefault=″qualified″>
  <xs:element name=″streamerContent″>
    <xs:element name=″channel>
    <xs:complexType>
      <xs:attribute name=″number″ type=″xs:string″ use=″required″/>
      <xs:attribute name=″name″ type=″xs:string″/>
      <xs:element name=″tunerID″ type=″xs:string″/>
      <xs:element name=″playlist-url″ type=″xs:string″/>
    </xs:complexType>
  </xs:element>
</xs:element>
</xs:schema>
```

Channel List

```
<?xml version=″1.0″ encoding=″utf-8″?>
<xs:schema xmlns:xs=″http://www.w3.org/2001/XMLSchema″
xmlns:wmh=″http://www.wmhelp.com/2003/eGenerator″ elementFormDefault=″qualified″>
  <xs:element name=″channelList″>
    <xs:element name=″sequenceNumber″/>
    <xs:complextype>
      <xs:sequence>
        <xs:element name=″channel>
          <xs:complexType>
            <xs:attribute name=″number″ type=″xs:string″ use=″required″/>
            <xs:attribute name=″name″ type=″xs:string″/>
          </xs:complexType>
        </xs:element>
      </xs :sequence>
    </xs :complexType>
  </xs:element>
</xs:schema>
```

Although embodiments of an object model for domain-based content mobility have been described in language specific to features and/or methods, the subject of the appended claims is not necessarily limited to the specific features or methods described. Rather, the specific features and methods are disclosed as example implementations of an object model for domain-based content mobility.

1.-2. (canceled)

3. A method for multimedia DNS (mDNS) support for an unsolicited channel change in a media server, the method comprising:
monitoring mDNS messages sent by the media server;
verifying that a channel change occurred in the media server;
sending a ChannelUpdate notification from a Domain to a NSNotification center;
sending the ChannelUpdate to the media server;
determining that a current channel cannot be found on any of one or more tuners;
forcing the channel change on one of the one or more tuners;
sending the notification of the forced channel change to one or snore client devices.

4. The method of claim 3, wherein the monitoring of messages is done via a Bonjour interface.

5. The method of claim 3, wherein the verifying that a channel change occurred in the server is done by sending a TXTRecordUpdate notification from an interface for monitoring to the domain for checking an Update type to confirm that the mDNS message is a channel change operation.

6. The method of claim 3, wherein the determining that the current channel cannot be found on any tuner is because there is no tuner available.

7. The method of claim 3, wherein the determining that the current channel cannot be found on any tuner is because of an emergency intervention broadcast.

8. The method of claim 3, wherein the determining that the current channel cannot be found on any tuner is because there is a parental control in place.

9. A method, comprising:
receiving a request, by a first end user device, for a list of programming in a form of a channel map;
sending to the end user device, the list of programming, comprising channel numbers and associated data;
receiving a request for a channel change from the end user device;
sending tune command, using HTTP, to a gateway device, indicating the channel selection made by a user of the first end device and causing a channel to change on a tuner; and
receiving a URI to a tuned output stream,
wherein the channel change forces other channels to change on the tuner resulting in an unsolicited channel change on at least a second end user device.

10. A system for mDNS support for unsolicited channel change; the system comprising:
a media server system for streaming live media content, the media server comprising:
a memory;
a processor for executing a set of instructions configured to:
passively observe queries and answers generated by other devices on the network;
receive notification that a channel change has occurred in the media server;
generate an mDNS notification, specifying a binding between a current channel and one or more tuners;
determine that the current channel cannot be accommodated on the one or more tuners;
force change the channel on one or more tuners, and
send notification to one or more end user devices affected by the channel change.

11. The system of claim 10, wherein the current channel cannot be accommodated on the one or more tuners because there is not a free tuner.

12. The system of claim 10, wherein the current channel cannot be accommodated on the one or more tuners because a current channel cannot be found on one of the other one or more tuners.

13. The system of claim 10, wherein the queries and answers are messages sent from the media server.

14. The system of claim 13, wherein a Bonjour interface monitors the messages sent from the media server and confirms that the message is a channel change operation.

15. The system of claim 10, wherein the system further comprises an NS notification center and a domain.

16. The system of claim 15, wherein the media server sends a ChannelChange notification to the domain, and
wherein the NSNotification center sends ChannelChange notification to one or more end user client devices.

17. The system of claim 10, wherein the media server shuffles an emergency service content onto the current channel and forces the emergency service content on all the tuners without any prior communication to the end user device.

18. The system of claim 10, wherein the processor is further configured to execute instructions for a ChannelUpdate notification to be sent from the Domain to the NS Notification center and for the Channel Update to be sent to the media server

19. The system of claim 10, also comprising:
an app for communicating with a media server, installed on an end user client device,
wherein the media server sends out a ChannelChange notification and NSNotification center sends ChannelChange notification to the app.

20. The system of claim 19, wherein the app receives the ChannelChange notification but exercises parental control and blocks the forced channel change.
